(19) United States
(12) Patent Application Publication
(10) Pub. No.: US 2010/0055260 A1
(43) Pub. Date: Mar. 4, 2010

(54) PACKAGE FOR HEATING A FOOD PRODUCT

(76) Inventor: Michael D. Sweet, Penacook, NH (US)

Correspondence Address: WOMBLE CARLYLE SANDRIDGE & RICE, PLLC, ATTN: PATENT DOCKETING, P.O. BOX 7037, ATLANTA, GA, 30357-0037, US

(21) Appl. No.: 12/580,452

(22) Filed: Oct. 16, 2009

Related U.S. Application Data
(63) Continuation of application No. PCT/US2008/062189, filed on May 1, 2008.
(60) Provisional application No. 60/915,143, filed on May 1, 2007.

(51) Int. Cl. B65D 81/34; H05B 6/80; B65D 5/42; A23L 1/01

(52) U.S. Cl. 426/243; 219/730; 229/115; 426/394

(57) ABSTRACT

A package for heating a food product. The package has a base for supporting the package on a surface, a support flap foldably connected to the base, and an end panel foldably connected to the base, and a tray for supporting a food product. The tray is foldably connected to the end panel and is for being supported above the base by the end panel and the support flap.

### CROSS REFERENCE TO RELATED APPLICATIONS

This application is a continuation application of prior PCT Application No. PCT/US2008/062189, filed May 1, 2008, entitled “Package For Heating A Food Product,” which PCT application claims the benefit of U.S. Provisional Application No. 60/915,143, filed May 1, 2007.

### INCORPORATION BY REFERENCE

The entire disclosures of both PCT Application No. PCT/US2008/062189, filed May 1, 2009, and U.S. Provisional Application No. 60/915,143, filed May 1, 2007, are incorporated herein by reference as if set forth in their entireties.

### BACKGROUND OF THE DISCLOSURE

The present disclosure generally relates to packages for holding and heating food products.

Cartons, constructs, or packages, such as paperboard packages, for holding food products such as frozen pizzas are known. The packages typically are square-shaped and are closed at the top, bottom, sides, front, and back to form a six-sided, fully enclosed package that contains the pizza and provides surface areas for printing graphics such as advertisements or nutritional information. It is desired to provide a package that is both suitable for holding one or more food products prior to preparation of the food product, and for holding the food product during heating in an oven, such as a microwave oven. Furthermore, and depending upon the circumstances, it may be desired to provide a package that enhances the heating, browning, and/or crisping of the food products in a microwave oven.

### SUMMARY OF SOME ASPECTS OF THE DISCLOSURE

In one aspect, the disclosure is generally directed to a package for holding a food product. The package comprises a base for supporting the package on a surface, a support flap foldably connected to the base, an end panel foldably connected to the base, and a tray for supporting a food product. The tray is foldably connected to the end panel for being supported above the base by the end panel and the support flap.

In another aspect, the disclosure is generally directed to a blank for forming a package for heating a food product. The blank comprises a first central panel and at least two first side panels foldably connected to the first central panel. The first central panel and the first side panels are for forming a tray. A second central panel and at least two second side panels are foldably connected to the second central panel. The second central panel and second side panels are for forming a base for supporting the package formed from the blank. An end panel is respectively foldably connected to the first central panel and the second central panel. A support flap is foldably connected to the second central panel. The support flap and the end panel are for supporting the tray above the base when the package is formed from the blank.

In another aspect, the disclosure is generally directed to a method of preparing a food product. The method comprises providing a package comprising a tray, and end panel foldably connected to the tray, and a cover foldably connected to the end panel. The cover covers the food tray in a closed position of the package. The method comprises opening the package comprising converting the cover into a base of the package by folding the tray relative to the end panel to place the food tray above the cover. The method comprises placing a food product in the tray, placing the opened package in a microwave oven by positioning the support on a surface of the microwave oven, and heating the food product in the microwave oven.

In another aspect, the disclosure is generally directed to a method of preparing a food product. The method comprising providing a package in a closed configuration so that a plurality of panels extends at least partially around an interior space of the package while the package is in the closed configuration. The plurality of panels includes a first panel and a second panel that are respectively foldably connected to opposite edges of an end panel. The first panel includes opposite first and second sides, and the second panel includes opposite first and second sides. In the closed configuration the interior space is at least partially positioned between the first side of the first panel and the first side of the second panel. The first side of the first panel faces toward the first side of the second panel. The method further comprises reconfiguring the package into an elevating configuration. The reconfiguring comprises causing relative folding between the first panel, the second panel, and the end panel so that, while the package is in the elevating configuration, at least a portion of the first panel is positioned above the second panel. Also, in the elevating configuration, the second side of the first panel faces toward, and is at least partially spaced apart from, the second side of the second panel. The reconfiguration further comprises providing a support that is distant from the end panel and supports at least the portion of the first panel above the second panel. The method further comprises heating the food product while the food product is upon the first side of the first panel and the package is in the elevating configuration.

Other aspects, features, and details of the present disclosure can be more completely understood by reference to the following detailed description of exemplary embodiments taken in conjunction with the drawings and from the appended claims.

The various features of the drawings discussed below are not necessarily drawn to scale. Dimensions of various features and elements in the drawings may be expanded or reduced to more clearly illustrate the embodiments of the disclosure.

### BRIEF DESCRIPTION OF THE DRAWINGS

FIG. 1 is a plan view of an exterior side of a blank used to form a package according to a first embodiment of the disclosure.

FIG. 2 is a plan view of an interior side of the blank.

FIGS. 3 and 4 are perspectives of the package in a partially assembled condition.

FIG. 5 is a perspective of the package.

FIG. 6 is a perspective of the package in a partially opened condition.

FIGS. 7 and 8 are perspectives of the opened package.

Corresponding parts are designated by corresponding reference numbers throughout the drawings.

### DETAILED DESCRIPTION OF THE EXEMPLARY EMBODIMENTS

The package of the present disclosure is particularly useful in containing a food product such as a piece of a frozen pizza during storage of the pizza prior to consumption. Further, the package of the present disclosure can be used for heating, cooking, browning, crisping, etc. the food product by use of a heating or cooking device such as a microwave oven. It is understood that food products other than pizza may be contained in the package. Further, food products contained in this package may be generally triangular, round, square, rectangular, or any other shape. In this specification, the terms “lower,” “bottom,” “upper” and “top” indicate orientations determined in relation to fully erected and upright packages.

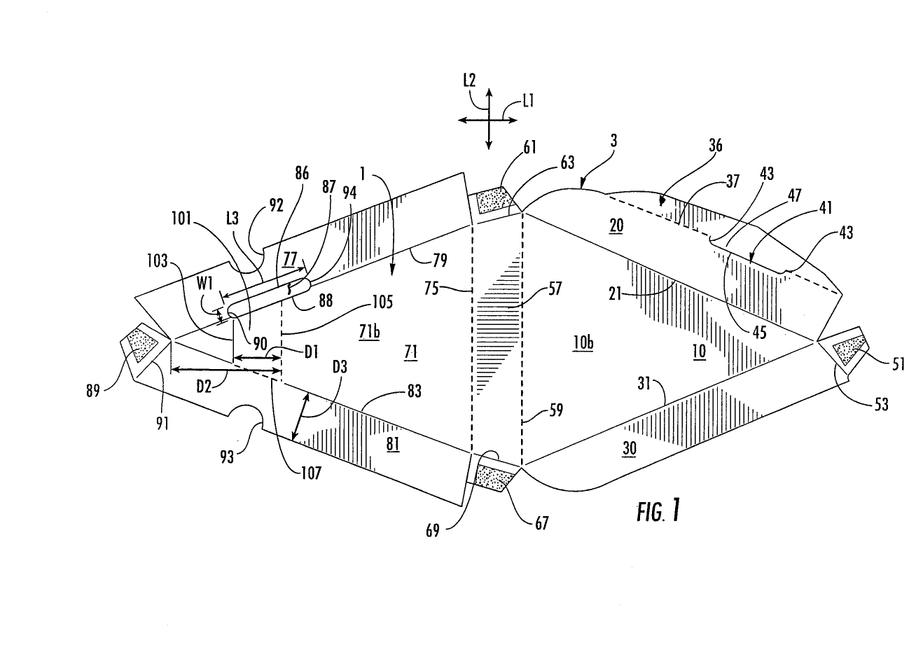

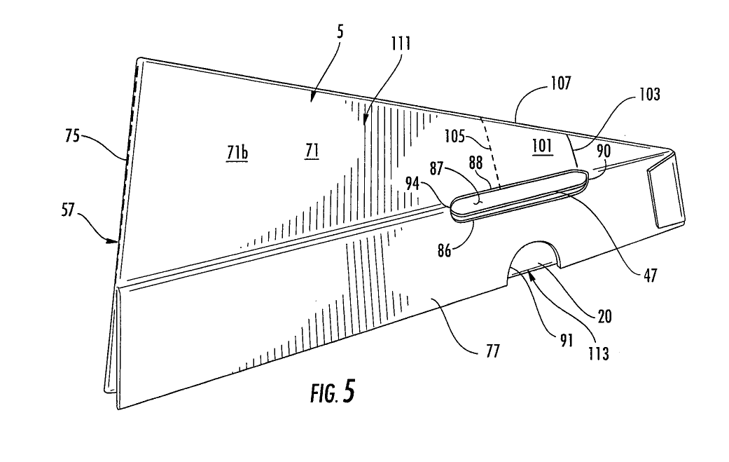

FIG. 1 is a plan view of an exterior side 1 of a blank, generally indicated at 3, used to form a package 5 (FIG. 5) according to the exemplary embodiment of the disclosure. The package 5 can be used to house a food product (e.g., a slice of pizza, not shown). In the illustrated embodiment, the package 5 is shaped to hold a single serving of pizza, which may be referred to herein as a slice, but the package could be otherwise shaped to hold correspondingly shaped food products. Further, the package 5 and blank 3 may be alternatively sized, shaped and/or otherwise arranged to hold any number of food products including a single food product or more than two food products. In the illustrated embodiment, the package 5 is sized to hold a triangular slice of pizza but the package may be otherwise sized and shaped for holding one or more servings of pizzas. The package 5 is particularly useful for holding the food product during storage in a freezer, during heating and/or cooking in a microwave oven (not shown), and/or during serving or consumption of the cooked food product.

The blank 3 has a longitudinal axis L1 and a lateral axis L2. In the illustrated embodiment, the blank 3 comprises a first central panel 10 foldably connected to a first side panel 20 at a first oblique fold line 21 and foldably connected to a second side panel 30 at a second oblique fold line 31. The first side panel 20 is foldably connected to a retention flap 36 at an oblique fold line 37. A notch 41 in the form of a cut or slit extends between two portions of the oblique fold line 37 and at least partially defines a locking portion 47 of the retention flap 36. The notch 41 has two transverse end portions 43 and an elongate portion 45 generally parallel to and spaced laterally inward from the fold line 37. The notch 41 at least partially forms a retention feature of the blank in the form of the locking portion 47 of the retention flap 36. The second side panel 30 has a corner tab 51 foldably attached to the side panel at an oblique fold line 53.

The first central panel 10 is foldably connected to an end panel 57 at a lateral fold line 59. A first end tab 61 is foldably connected to the end panel 57 at a first oblique fold line 63, and a second end tab 67 is foldably connected to the end panel at a second oblique fold line 69.

A second central panel 71 is foldably connected to the end panel 57 at a lateral fold line 75. The second central panel 71 is foldably connected to a first side panel 77 at a first oblique fold line 79 and is foldably connected to a second side panel 81 at a second oblique fold line 83. The first side panel 77 has an elongate opening or slot 87 (e.g., cutout) generally parallel to and extending between portions of the fold line 79. In the illustrated embodiment, the elongate opening 87 comprises two generally parallel edges 86, 88 and two rounded edges 90, 94 connecting the parallel edges. The opening 87 is positioned at a location corresponding with a top edge of the second panel. The edge 86 of the opening 87 is in the first side panel 77 and the edge 88 of the opening is in the second central panel 71. The rounded edges 90, 94 respectively extend from the edge 88 in the second central panel 71 to the edge 86 in the first side panel 77. A corner tab 89 is foldably connected to the second side panel 81 at an oblique fold line 91. The first side panel 77 and second side panel 81 each have a notch 92, 93 in a respective edge of the side panel. In the illustrated embodiment, the notches 92, 93 are in respective longitudinal edges of the side panels 77, 81 and are generally aligned in the longitudinal direction of the blank. It is understood that the notches 92, 93 may be omitted or the notches may be otherwise shaped, arranged, and located without departing from the disclosure.

In the illustrated embodiment, a support flap 101 is foldably attached to the second central panel 71 at a lateral fold line 103 extending between the oblique fold lines 79, 83. The support flap 101 is at least partially defined by a lateral tear line 105 extending between the oblique fold lines 79, 83 and generally parallel to the lateral fold line 103. The support flap 101 is further at least partially defined by an oblique tear line 107 extending between the lateral fold line 103 and the lateral tear line 105. In the illustrated embodiment, the oblique tear line 107 extends between and is generally aligned with portions of the oblique fold line 83. The support flap 101 is further at least partially defined at a lateral end opposite the oblique tear line 107 by a portion of the elongate opening 87. Differently configured supports (e.g., support flaps) are also within the scope of the present disclosure and can be positioned differently than illustrated herein.

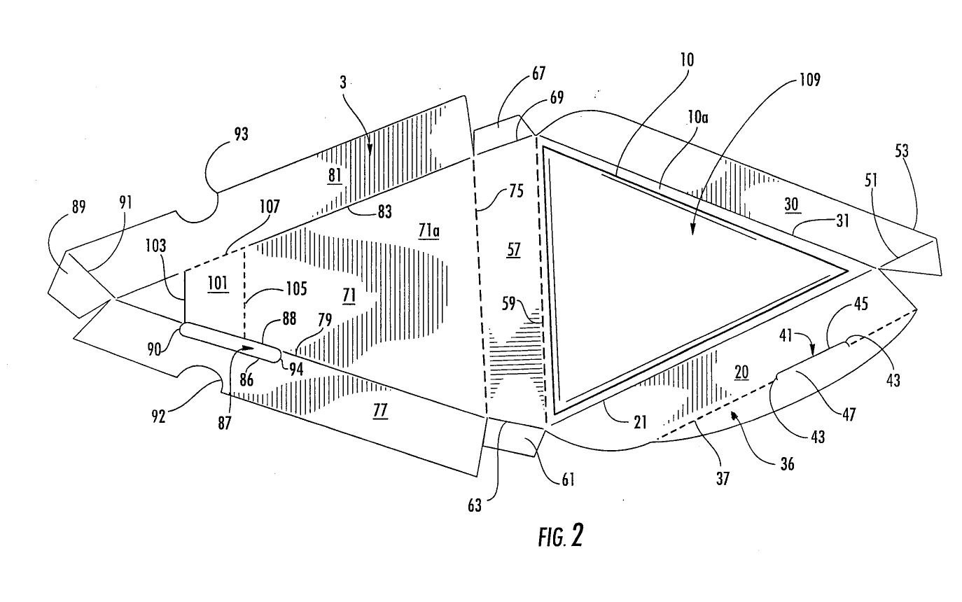

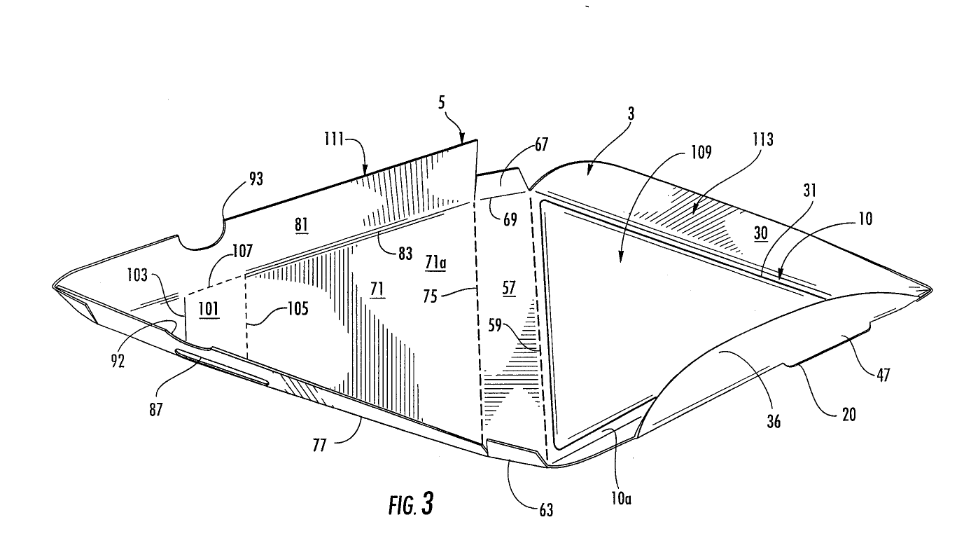

In the illustrated embodiment, the first central panel 10 includes at least one microwave energy interactive element 109 (FIG. 2) attached thereto (e.g., covering at least a portion of the interior surface of the bottom panel of the blank 3). In accordance with the exemplary embodiment of the present disclosure, the microwave energy interactive element 109 may comprise a susceptor for becoming hot when exposed to microwave energy, although other types and various combinations of microwave energy interactive elements are also within the scope of the present disclosure, as will be discussed below. Additionally, the blank 3 may include other microwave energy interactive elements overlying one or more other panels, for example, the second central panel 71, and/or one or more of the side panels 20, 30, 77, 81 and end panel 57. It also will be understood that the microwave energy interactive element 109 may be omitted from the blank 3.

In the illustrated embodiment, the elongate opening 87 has a length L3 and a width W1, and the retention flap 47 has a length L4. In one exemplary embodiment, the length L3 is at least approximately 2.4 inches (61 mm), the width W1 is at least approximately ⅛ inch (3.0 mm), and the length L4 is approximately 2¼ inches (57 mm). In the illustrated embodiment the support flap 101 has a width D1, the fold line 105 is spaced from a junction of the oblique fold lines 79, 83 by a distance D2, and the second side panels 77, 81 have a width D3. In one exemplary embodiment, the width D1 is at least approximately 1⅜ inch (35 mm), the distance D2 is at least approximately 3 inches (76 mm), and the width D3 is at least approximately 1.4 inches (35 mm). The dimensional information listed herein is intended to be exemplary only and is not intended to limit the scope of the disclosure. Further, the blank 3 may have dimensions other than listed herein without departing from the disclosure.

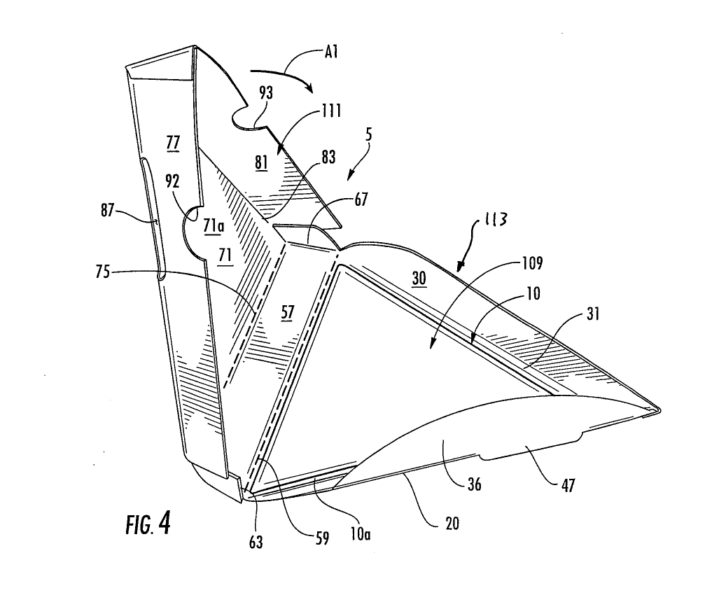

In accordance with the exemplary embodiment, the blank 3 can be erected into the package 5 by first folding along fold lines 21, 31, 79, 83 to upwardly fold the side panels 20, 30, 77, 81 relative to the first and second central panels 10, 71. The corner tabs 51, 89 are respectively inwardly folded along fold lines 53, 91 so as to be in generally face-to-face contact with a respective inner surface of an opposite side panel 20, 77. The corner tabs 51, 89 may be respectively adhesively attached to one of the side panels 20, 77 by an adhesive such as glue. The retention flap 36 is inwardly folded relative to the side panel 20 so that the retention flap is generally parallel to the first central panel 10 and the locking portion 47 is struck from and protrudes in a generally horizontal direction relative to the side panel 20. In the illustrated embodiment, the locking portion 47 of the retention flap 36 is located at the top edge of the side panel 20 at a height corresponding to the location of the oblique fold line 37. The upwardly folded side panels 21, 30, 77, 81 and inwardly folded corner tabs 51, 89 form generally opposed, triangular trays (e.g., first tray 113 and second tray 111) that are foldably connected to opposite sides of the end panel 57. As shown in FIG. 4, the second tray 111 is folded over the first tray 113, generally in the direction of arrow A1, by folding along fold lines 59, 75 so that the end panel 57 is in a generally vertical position. The second tray 111 is further folded in the direction of arrow A1 so that the side panels 77, 81 overlap and are in generally face-to-face contact with the side panels 20, 30 of the first tray 113 to close the package 5. When the second tray 111 is lowered over the first tray 113, the locking portion 47 of the retention flap 36 is received in the elongate slot 87 to secure the package 5 in the closed position. The retention features of the blank (e.g., the locking portion 47 and the elongate slot 87) releasably secure the second tray 111 in the closed position covering the first tray 113. The retention features may be positioned differently. For example, the locking portion 47 may be positioned where the elongate slot 87 is shown, and the elongate slot 87 may be positioned where the flap 47 is shown. Alternatively, the first tray or cover 113 may be arranged to be lowered over the second tray 111 to secure the package 5 in the closed position. Food product may be placed in the package 5 (e.g., in the first tray 113) at any point in the closing process. Adhesive such as glue may be applied to one or more of the corner tabs 51, 89, end tabs 61, 67, and side panels 20, 30, 77, 81 to secure the second tray 111 in the closed position covering the first tray 113. Further, an overwrap of plastic material or other securement methods may be used to secure the second tray 111 in the closed position covering the first tray 113.

To heat the food product in the package 5, the package is first opened by raising the second tray 111 from the closed position and preparing the food product for heating. The second tray 111 may be grasped by the notches 91, 93 in the side panels 77, 81 and raised to allow access to the food product in the package 5. For example, the food product may be a frozen pizza slice that has a protective overwrap of plastic material that is removed from the pizza before heating.

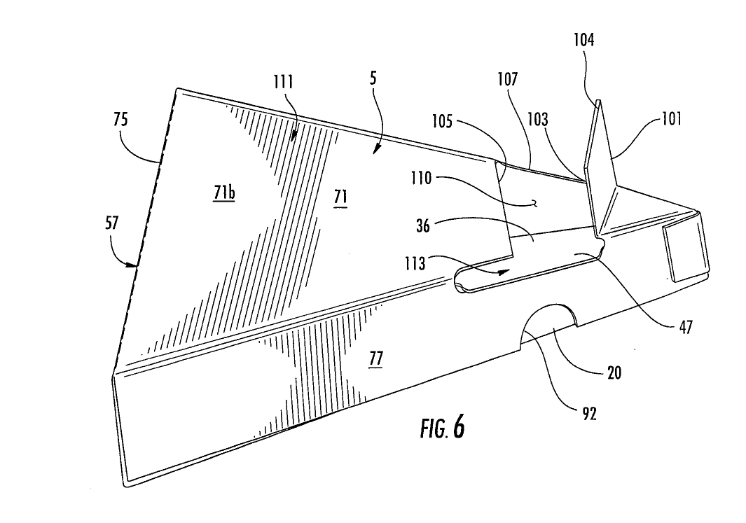

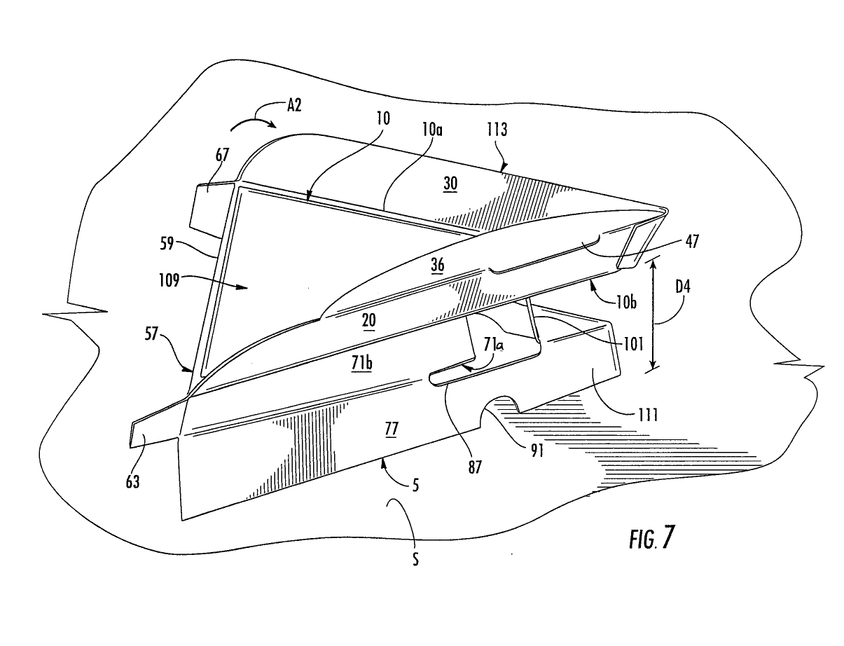

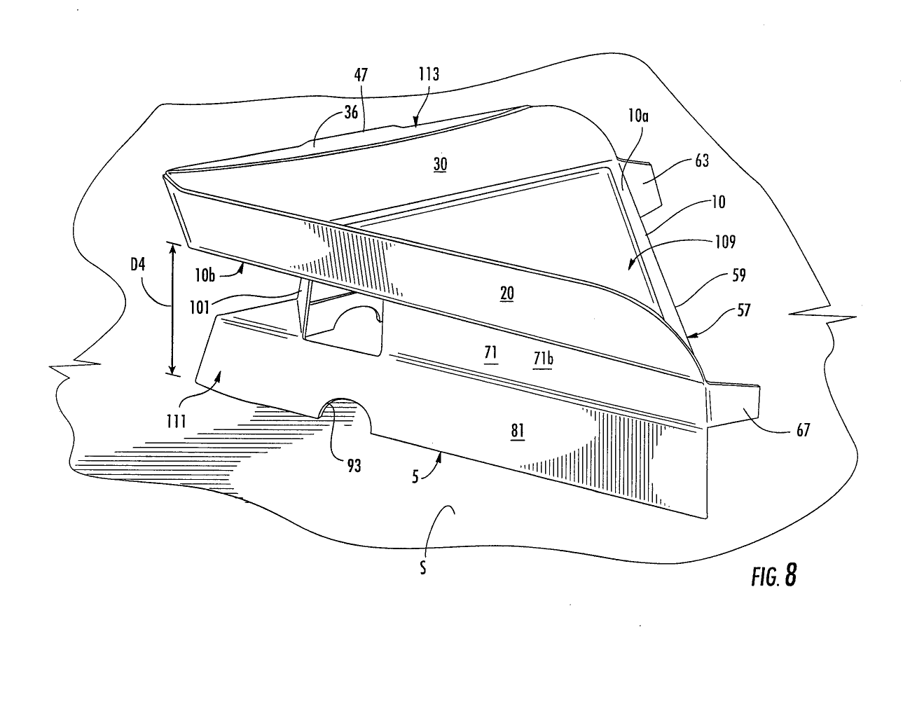

As shown in FIGS. 7-8, the package 5 is assembled for supporting the food product during heating at an elevation above a bottom surface S (shown partially in FIGS. 7 and 8) of a microwave oven. In the illustrated embodiment, the package 5 may be converted to a package having two tiers, the top tier being the first tray 113 that holds the food product and the bottom tier being the second tray or cover 111 that is a base for supporting the first tray 113 when the two-tiered package is placed in the oven. After the food product is removed, the package 5 may be returned to the closed position shown in FIG. 5 with the cover 111 lowered and covering the first tray 113, or the package may be further assembled to the two-tiered configuration shown in FIGS. 7 and 8 from a partially opened position with the cover 111 not completely covering the first tray 113. As shown in FIG. 6, the support flap 101 is grasped through the elongate opening 87 and torn along tear lines 105, 107 to actuate the support flap so that the support flap is partially separated from the second central panel 71 and upwardly struck from the second central panel. The support flap 101 is folded upward relative to the top panel 71 along fold line 103 and is positioned as generally illustrated in FIG. 6 with a free edge 104 of the support flap spaced apart from the second central panel 71 by the distance D1 corresponding to the width of the support flap. The first tray 113 is positioned as the top tier by rotating the first tray 360 degrees to position the first tray above the base 111 as shown in FIGS. 7 and 8. To achieve the position shown in FIGS. 7 and 8, the first tray 113 and end panel 57 are rotated around the base 11, with the base remaining substantially in the same position as shown in FIG. 6. In one embodiment, the first tray 113 is first rotated 90 degrees about fold line 59. Then the end panel 57 is inverted by rotating the end panel 180 degrees (from the position shown in FIG. 6) about fold line 75 which rotates the first tray 113 an additional 180 degrees and positions the first tray in a generally upright position. Next, the first tray 113 is then rotated downward 90 degrees relative to the fold line 59 in the direction of arrow A2 (FIG. 7) to the position shown in FIGS. 7 and 8.

In the position shown in FIGS. 7 and 8, the package 5 forms the two-tier configuration with the first tray 113 forming the top tier and being supported by the support flap 101 and the end panel 57 at a spaced-apart elevation from the base 111 that forms the lower tier. In the position of FIGS. 7 and 8, the first tray 113 is spaced above a surface S by a distance D4 equal to the width D3 (FIG. 1) of the second side panels 77, 81 plus the width D1 (FIG. 1) of the upwardly struck support flap 101. In one embodiment, the distance D4 is at least approximately 2 inches (50 mm), and may be more or less than this amount without departing from the disclosure.

The unwrapped pizza is placed in the top tier/first tray 113 against the microwave energy interactive element 109 on the first central panel 10 and is heated by operating the microwave oven. When the microwave oven is operated, the microwave energy interactive element 109 generate heat that heats, cooks, browns, and/or crisps the pizza. In the assembled position of FIGS. 7 and 8, the inner surface of the first central panel 10 having the microwave interactive element 109 is spaced apart from the bottom surface S of the microwave oven by a distance D3 so that the food product is closer to the center of the oven to promote more uniform heating of the food product and so that the food product is spaced away from the surface S that may be a heat sink. After heating, the pizza may be removed from the first tray 113 of the package 5 or the package may be used as a serving tray. It is understood that the package 5 may be assembled in the two-tier configuration or heating position shown in FIGS. 7 and 8 by other alternative steps and processes as discussed herein. Also, the assembly of the package 5 may be in the same or different order as the opening, closing, position, or steps discussed above. Further, the package 5 may be alternatively arranged and may have other flaps, fold lines, tear lines, etc. without departing from the disclosure.

The above described method of preparing the food product comprises providing the package 5 in a closed configuration (FIG. 5) so that a plurality of panels 71, 77, 81, 57, 10, 20, 30 extends at least partially around an interior space 110 (FIG. 6) of the package while the package is in the closed configuration. The plurality of panels includes a first panel (e.g., central panel 10) and a second panel (e.g., central panel 71) that are respectively foldably connected to opposite edges of the end panel 57. The first panel 10 includes opposite first and second sides 10a, 10b, and the second panel 71 includes opposite first and second sides 71a, 71b. In the closed configuration the interior space 110 is at least partially positioned between the first side 10a of the first panel 10 and the first side 71a of the second panel 71, and the first side 10a of the first panel 10 faces toward the first side 71a of the second panel 71. The method comprises reconfiguring the package 5 into an elevating configuration (FIGS. 7 and 8). The reconfiguring comprises causing relative folding between the first panel 10, the second panel 71 and the end panel 57 so that, while the package 5 is in the elevating configuration at least a portion of the first panel 10 is positioned above the second panel 71, and the second side 10b of the first panel faces toward, and is at least partially spaced apart from, the second side 71b of the second panel 71. In the illustrated embodiment, the orientation of the first panel 10 and second panel 71 in the elevating configuration is obtained by rotating the first tray 113 (comprising the first central panel 10) approximately 360 degrees from the closed configuration of FIG. 5 to the elevating position of FIGS. 7 and 8. The reconfiguring further comprises providing a support (e.g., support flap 101) that is distant from the end panel 57 and supports at least the portion of the first panel 10 above the second panel 71. In the illustrated embodiment, the support is provided by upwardly folding the support flap 101 relative to the second panel 71. In the elevating position the first panel 10 is supported above the second panel 71 by the upwardly struck support flap 101 and the end panel 57 that is inverted from the closed configuration of FIG. 5. The method further comprises heating the food product while the food product is upon the first side of the first panel 10 and the package 5 is in the elevating configuration.

The package 5 may be used in a similar manner to heat and/or cook a second food product that was originally contained in the package. Further, the package 5 may be used to reheat portions of previously cooked pizzas, or the package may be used to heat food products other than the pizza originally packaged in the package. The package 5, or portions of the package, can be used as a serving plate for serving the cooked or heated pizza slice. In one example, the first tray 113 and/or second tray 111 may be separated by tearing along fold line 75 so that either or both of the first and second trays may be used a serving tray. Furthermore, the second tray/base/cover 111 can be removed from the package 5 before heating the pizza slice in the microwave oven. Alternatively, the food product can be heated in the package 5 when the package 5 is in the closed position of FIG. 5 with the second tray 111 covering the first tray 113.

Various microwave energy interactive elements may be suitable for use with the package 5 of the present disclosure. For example, the microwave energy interactive elements 109 (hereinafter sometimes referred to as “microwave interactive element”) may promote browning and/or crisping of a particular area of the food item, shield a particular area of the food item from microwave energy to prevent overcooking thereof, or transmit microwave energy towards or away from a particular area of the food item. Each microwave interactive element comprises one or more microwave energy interactive materials or segments arranged in a particular configuration to absorb microwave energy, transmit microwave energy, reflect microwave energy, or direct microwave energy, as needed or desired for a particular construct and food item.

The microwave interactive element may be supported on a microwave inactive or transparent substrate for ease of handling and/or to prevent contact between the microwave interactive material and the food item. As a matter of convenience and not limitation, and although it is understood that a microwave interactive element supported on a microwave transparent substrate includes both microwave interactive and microwave inactive elements or components, such constructs are referred to herein as “microwave interactive webs”.

The microwave energy interactive material may be an electroconductive or semiconductive material, for example, a metal or a metal alloy provided as a metal foil; a vacuum deposited metal or metal alloy; or a metallic ink, an organic ink, an inorganic ink, a metallic paste, an organic paste, an inorganic paste, or any combination thereof. Examples of metals and metal alloys that may be suitable for use with the package 5 of the present disclosure include, but are not limited to, aluminum, chromium, copper, inconel alloys (nickel-chromium-molybdenum alloy with niobium), iron, magnesium, nickel, stainless steel, tin, titanium, tungsten, and any combination or alloy thereof.

Alternatively, the microwave energy interactive material may comprise a metal oxide. Examples of metal oxides that may be suitable for use with the present disclosure include, but are not limited to, oxides of aluminum, iron, and tin, used in conjunction with an electrically conductive material where needed. Another example of a metal oxide that may be suitable for use with the present disclosure is indium tin oxide (ITO). ITO can be used as a microwave energy interactive material to provide a heating effect, a shielding effect, a browning and/or crisping effect, or a combination thereof. For example, to form a susceptor, ITO may be sputtered onto a clear polymeric film. The sputtering process typically occurs at a lower temperature than the evaporative deposition process used for metal deposition. ITO has a more uniform crystal structure and, therefore, is clear at most coating thicknesses. Additionally, ITO can be used for either heating or field management effects. ITO also may have fewer defects than metals, thereby making thick coatings of ITO more suitable for field management than thick coatings of metals, such as aluminum.

Alternatively, the microwave energy interactive material may comprise a suitable electroconductive, semiconductive, or non-conductive artificial dielectric or ferroelectric. Artificial dielectrics comprise conductive, subdivided material in a polymeric or other suitable matrix or binder, and may include flakes of an electroconductive metal, for example, aluminum.

In one example, the microwave interactive element may comprise a thin layer of microwave interactive material that tends to absorb microwave energy, thereby generating heat at the interface with a food item. Such elements often are used to promote browning and/or crisping of the surface of a food item (sometimes referred to as a “browning and/or crisping element”). When supported on a film or other substrate, such an element may be referred to as a “susceptor film” or, simply, “susceptor”. However, other microwave energy interactive elements, such as those described herein, are contemplated hereby.

As another example, the microwave interactive element may comprise a foil having a thickness sufficient to shield one or more selected portions of the food item from microwave energy (sometimes referred to as a “shielding element”). Such shielding elements may be used where the food item is prone to scorching or drying out during heating.

The shielding element may be formed from various materials and may have various configurations, depending on the particular application for which the shielding element is used. Typically, the shielding element is formed from a conductive, reflective metal or metal alloy, for example, aluminum, copper, or stainless steel. The shielding element generally may have a thickness of from about 0.000285 inches to about 0.05 inches. In one aspect, the shielding element has a thickness of from about 0.0003 inches to about 0.03 inches. In another aspect, the shielding element has a thickness of from about 0.00035 inches to about 0.020 inches, for example, 0.016 inches.

As still another example, the microwave interactive element may comprise a segmented foil, such as, but not limited to, those described in U.S. Pat. Nos. 6,204,492, 6,433,322, 6,552,315, and 6,677,563, each of which is incorporated by reference in its entirety. Although segmented foils are not continuous, appropriately spaced groupings of such segments often act as a transmitting element to direct microwave energy to specific areas of the food item. Such foils also may be used in combination with browning and/or crisping elements, for example, susceptors.

Any of the numerous microwave interactive elements described herein or contemplated hereby may be substantially continuous, that is, without substantial breaks or interruptions, or may be discontinuous, for example, by including one or more breaks or apertures that transmit microwave energy therethrough. The breaks or apertures may be sized and positioned to heat particular areas of the food item selectively. The number, shape, size, and positioning of such breaks or apertures may vary for a particular application depending on type of construct being formed, the food item to be heated therein or thereon, the desired degree of shielding, browning, and/or crisping, whether direct exposure to microwave energy is needed or desired to attain uniform heating of the food item, the need for regulating the change in temperature of the food item through direct heating, and whether and to what extent there is a need for venting.

It will be understood that the aperture may be a physical aperture or void in the material used to form the construct, or may be a non-physical “aperture”. A non-physical aperture may be a portion of the construct that is microwave energy inactive by deactivation or otherwise, or one that is otherwise transparent to microwave energy. Thus, for example, the aperture may be a portion of the construct formed without a microwave energy active material or, alternatively, may be a portion of the construct formed with a microwave energy active material that has been deactivated. While both physical and non-physical apertures allow the food item to be heated directly by the microwave energy, a physical aperture also provides a venting function to allow steam or other vapors to be released from the food item. It also may be beneficial to create one or more discontinuities or inactive regions to prevent overheating or charring of the package.

As stated above, any of the above elements and numerous others contemplated hereby may be supported on a substrate. The substrate typically comprises for example, a polymer film or other polymeric material. As used herein the term “polymer” or “polymeric material” includes, but is not limited to, homopolymers, copolymers, such as for example, block, graft, random, and alternating copolymers, terpolymers, etc. and blends and modifications thereof. Furthermore, unless otherwise specifically limited, the term “polymer” shall include all possible geometrical configurations of the molecule. These configurations include, but are not limited to isotactic, syndiotactic, and random symmetries.

The thickness of the film typically may be from about 35 gauge to about 10 mil. In one aspect, the thickness of the film is from about 40 to about 80 gauge. In another aspect, the thickness of the film is from about 45 to about 50 gauge. In still another aspect, the thickness of the film is about 48 gauge. Examples of polymeric films that may be suitable include, but are not limited to, polyolefins, polyesters, polyamides, polyimides, polysulfones, polyether ketones, cellophanes, or any combination thereof. Other non-conducting substrate materials such as paper and paper laminates, metal oxides, silicates, cellulosics, or any combination thereof, also may be used.

In one example, the polymeric film comprises polyethylene terephthalate (PET). Polyethylene terephthalate films are used in commercially available susceptors, for example, the QWIKWAVE® susceptor and the MICRORITE® susceptor laminations, both available from Graphic Packaging International (Marietta, Ga.). Examples of polyethylene terephthalate films that may be suitable for use as the substrate include, but are not limited to, MELINEXT® films, commercially available from DuPont Teijan Films (Hopewell, Va.), SKYROL films, commercially available from SKC, Inc. (Covington, Ga.), and BARRIALOX PET films, available from Toray Films (Front Royal, Va.), and QU50 High Barrier Coated PET films, available from Toray Films (Front Royal, Va.).

The polymeric film may be selected to impart various properties to the paper or paperboard web, for example, printability, heat resistance, or any other property. As one particular example, the polymeric film may be selected to provide a water barrier, oxygen barrier, or a combination thereof. Such barrier film layers may be formed from a polymer film having barrier properties or from any other barrier layer or coating as desired. Suitable polymer films may include, but are not limited to, ethylene vinyl alcohol, barrier nylon, polyvinylidene chloride, barrier fluoropolymer, nylon 6, nylon 6,6, coextruded nylon 6/EVOH/nylon 6, silicon oxide coated film, barrier polyethylene terephthalate, or any combination thereof.

One example of a barrier film that may be suitable for use with the present disclosure is CAPRAN® EMBLEM 1200M nylon 6 film, commercially available from Honeywell International (Pottsville, Pa.). Another example of a barrier film that may be suitable is CAPRAN® OXYSHIELD OBS monoaxially oriented coextruded nylon 6/ethylene vinyl alcohol (EVOH)/nylon 6 film, also commercially available from Honeywell International. Yet another example of a barrier film that may be suitable for use with the present disclosure is DARTEK® N-201 nylon 6,6 film, commercially available from Enhance Packaging Technologies (Webster, N.Y.). Additional examples include BARRIALOX PET, available from Toray Films (Front Royal, Va.) and QU50 High Barrier Coated PET film, available from Toray Films (Front Royal, Va.), referred to above.

Still other barrier films include silicon oxide coated films, such as those available from Sheldahl Films (Northfield, Minn.). Thus, in one example, a susceptor may have a structure including a film, for example, polyethylene terephthalate, with a layer of silicon oxide coated onto the film, and ITO or other material deposited over the silicon oxide. If needed or desired, additional layers or coatings may be provided to shield the individual layers from damage during processing.

The barrier film may have an oxygen transmission rate (OTR) as measured using ASTM D3985 of less than about 20 cc/m2/day. In one aspect, the barrier film has an OTR of less than about 10 cc/m2/day. In another aspect, the barrier film has an OTR of less than about 1 cc/m2/day. In still another aspect, the barrier film has an OTR of less than about 0.5 cc/m2/day. In yet another aspect, the barrier film has an OTR of less than about 0.1 cc/m2/day.

The barrier film may have a water vapor transmission rate (WVTR) of less than about 100 g/m2/day as measured using ASTM F1249. In one aspect, the barrier film has a water vapor transmission rate of less than about 50 g/m2/day. In another aspect, the barrier film has a WVTR of less than about 15 g/m2/day. In yet another aspect, the barrier film has a WVTR of less than about 1 g/m2/day. In still another aspect, the barrier film has a WVTR of less than about 0.1 g/m2/day. In a still further aspect, the barrier film has a WVTR of less than about 0.05 g/m2/day.

Other non-conducting substrate materials such as metal oxides, silicates, cellulosics, or any combination thereof, also may be used in accordance with the present disclosure.

The microwave energy interactive material may be applied to the substrate in any suitable manner, and in some instances, the microwave energy interactive material is printed on, extruded onto, sputtered onto, evaporated on, or laminated to the substrate. The microwave energy interactive material may be applied to the substrate in any pattern, and using any technique, to achieve the desired heating effect of the food item.

The microwave interactive element or microwave interactive web may be joined to or overlie a dimensionally stable, microwave energy transparent support (hereinafter referred to as “microwave transparent support”, “microwave inactive support” or “support”) to form the construct.

For example, the microwave energy interactive material may be provided as a continuous or discontinuous layer or coating including circles, loops, hexagons, islands, squares, rectangles, octagons, and so forth. Examples of various patterns and methods that may be suitable for use with the present disclosure are provided in U.S. Pat. Nos. 6,765,182; 6,717,121; 6,677,563; 6,552,315; 6,455,827; 6,433,322; 6,414,290; 6,251,451; 6,204,492; 6,150,646; 6,114,679; 5,800,724; 5,759,422; 5,672,407; 5,628,921; 5,519,195; 5,424,517; 5,410,135; 5,354,973; 5,340,436; 5,266,386; 5,260,537; 5,221,419; 5,213,902; 5,117,078; 5,039,364; 4,963,424; 4,936,935; 4,890,439; 4,775,771; 4,865,921; and Re. 34,683, each of which is incorporated by reference herein in its entirety. Although particular examples of patterns of microwave energy interactive material are shown and described herein, it should be understood that other patterns of microwave energy interactive material are contemplated by the present disclosure.

In one aspect, for example, where a rigid or semi-rigid construct is to be formed, all or a portion of the support may be formed at least partially from a paperboard material, which may be cut into a blank prior to use in the construct. For example, the support may be formed from paperboard having a basis weight of from about 60 to about 330 lbs/ream (i.e., lbs/3,000 ft²), for example, from about 80 to about 140 lbs/ream. The paperboard generally may have a thickness of from about 6 to about 30 mils, for example, from about 12 to about 28 mils. In one particular example, the paperboard has a thickness of about 18 mils and a basis weight of from about 100 lbs/ream to about 300 lbs/ream. Any suitable paperboard may be used, for example, a solid bleached or solid unbleached sulfate board, such as SUS® board, commercially available from Graphic Packaging International.

Furthermore, the blanks or other constructs may be coated with, for example, a moisture and/or oxygen barrier layer, on either or both sides, such as those described above. Any suitable moisture and/or oxygen barrier material may be used in accordance with the present disclosure. Examples of materials that may be suitable include, but are not limited to, polyvinylidene chloride, ethylene vinyl alcohol, DuPont DARTEK™ nylon 6,6 film, and others referred to above.

Alternatively or additionally, any of the blanks or other constructs of the present disclosure may be coated or laminated with other materials to impart other properties, such as absorbency, repellency, opacity, color, printability, stiffness, or cushioning. For example, absorbent susceptors are described in U.S. Provisional Application No. 60/604,637, filed Aug. 25, 2004, and U.S. patent application Ser. No. 11/211,858, to Middleton, et al., titled “Absorbent Microwave Interactive Packaging”, filed Aug. 25, 2005, both of which are incorporated herein by reference in their entirety. Additionally, the blanks or other constructs may include graphics or indicia printed thereon. It will be understood that with some combinations of elements and materials, the microwave interactive element may have a grey or silver color that is visually distinguishable from the substrate or the support. However, in some instances, it may be desirable to provide a web or construct having a uniform color and/or appearance. Such a web or construct may be more aesthetically pleasing to a consumer, particularly when the consumer is accustomed to packages or containers having certain visual attributes, for example, a solid color, a particular pattern, and so on. Thus, for example, the present disclosure contemplates using a silver or grey toned adhesive to join the microwave interactive elements to the substrate, using a silver or grey toned substrate to mask the presence of the silver or grey toned microwave interactive element, using a dark toned substrate, for example, a black toned substrate, to conceal the presence of the silver or grey toned microwave interactive element, overprinting the metallized side of the web with a silver or grey toned ink to obscure the color variation, printing the non-metallized side of the web with a silver or grey ink or other concealing color in a suitable pattern or as a solid color layer to mask or conceal the presence of the microwave interactive element, or any other suitable technique or combination thereof.

As another example, the microwave interactive element may comprise a microwave energy interactive insulating material. As used herein, the term “microwave energy interactive insulating material” or “insulating material” refers any combination of layers of materials that is both responsive to microwave energy and capable of providing some degree of thermal insulation when used to heat a food item.

The insulating material may include various components, provided that each is resistant to softening, scorching, combusting, or degrading at typical microwave oven heating temperatures, for example, at about 250° F. The insulating material may include both microwave energy responsive or interactive components, and microwave energy transparent or inactive components. For example, the insulating material may comprise one or more susceptor layers in combination with one or more expandable insulating cells. Additionally, the insulating material may include one or more microwave energy transparent or inactive materials to provide dimensional stability, to improve ease of handling the microwave energy interactive material, and/or to prevent contact between the microwave energy interactive material and the food item. In one particular example, the microwave energy interactive insulating material comprises a microwave energy interactive material supported on a first polymeric film layer, a moisture-containing layer superposed with the microwave energy interactive material and a second polymeric film layer joined to the moisture-containing layer in a predetermined pattern, thereby forming one or more closed cells between the moisture-containing layer and the second polymeric film layer. The closed cells expand or inflate in response to being exposed to microwave energy, and thereby causing microwave energy interactive material to bulge and deform toward the food product. In doing so, the heat generated by the microwave energy interactive material is transferred to the food product more readily. Additional benefits and aspects of such materials are described in PCT Application No. PCT/US03/03779, U.S. application Ser. No. 10/501,003, and U.S. application Ser. No. 11/314,851, each of which is incorporated by reference herein in its entirety.

The blank according to the present disclosure can be, for example, formed from coated paperboard and similar materials. For example, the interior and/or exterior sides of the blank can be coated with a clay coating. The clay coating may then be printed over with product, advertising, price coding, and other information or images. The blank may then be coated with a varnish to protect any information printed on the blank. The blank may also be coated with, for example, a moisture barrier layer, on either or both sides of the blank. In accordance with the above-described embodiments, the blank may be constructed of paperboard of a caliper such that it is heavier and more rigid than ordinary paper. The blank can also be constructed of other materials, such as cardboard, hard paper, or any other material having properties suitable for enabling the package to function at least generally as described herein. The blank can also be laminated or coated with one or more sheet-like materials at selected panels or panel sections.

In accordance with the above-described embodiments of the present disclosure, a fold line can be any substantially linear, although not necessarily straight, form of weakening that facilitates folding therealong. More specifically, but not for the purpose of narrowing the scope of the present disclosure, fold lines may include: a score line, such as lines formed with a blunt scoring knife, or the like, which creates a crushed portion in the material along the desired line of weakness; a cut that extends partially into a material along the desired line of weakness, and/or a series of cuts that extend partially into and/or completely through the material along the desired line of weakness; and various combinations of these features.

As an example, a tear line can include: a slit that extends partially into the material along the desired line of weakness, and/or a series of spaced apart slits that extend partially into and/or completely through the material along the desired line of weakness, or various combinations of these features. As a more specific example, one type tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the tear lines to be replaced with a continuous slit, or the like. For example, a cut line can be a continuous slit or could be wider than a slit without departing from the present disclosure.

The above embodiments may be described as having one or more panels adhered together by glue during erection of the package embodiments. The term “glue” is intended to encompass all manner of adhesives commonly used to secure package panels in place.

The foregoing description illustrates and describes various embodiments of the present disclosure. As various changes could be made in the above construction, it is intended that all matter contained in the above description or shown in the accompanying drawings shall be interpreted as illustrative and not in a limiting sense. Furthermore, the present disclosure covers various modifications, combinations, and alterations, etc., of the above-described embodiments that are within the scope of the claims. Additionally, the disclosure shows and describes only selected embodiments, but various other combinations, modifications, and environments are within the scope of the disclosure as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A package for heating a food product, the package comprising:
a base for supporting the package on a surface;
a support flap foldably connected to the base;
an end panel foldably connected to the base;
a tray for supporting a food product, the tray being foldably connected to the end panel for being supported above the base by the end panel and the support flap.

2. The package of claim 1 wherein the base comprises a cover that covers the tray in a closed position of the package.

3. The package of claim 1 wherein the tray is a first tray comprising a first central panel and at least two first side panels foldably connected to the first central panel, and the base comprises a second central panel and at least two second side panels foldably connected to the second central panel.

4. The package of claim 3 wherein the support flap is foldably connected to the second central panel.

5. The package of claim 4 wherein the support flap has a free edge for supporting the tray above the base.

6. The package of claim 4 wherein the second central panel comprises a tear line for at least partially separating the support flap from the second central panel.

7. The package of claim 6 wherein the second central panel comprises a fold line for positioning the support flap relative to the second central panel.

8. The package of claim 3 wherein the cover comprises an opening in at least one of the second side panels and the first tray comprises a retention flap foldably connected to at least one of the first side panels, the retention flap having a locking portion for being at least partially received in the opening to retain the cover in the closed position of the package.

9. The package of claim 3 wherein the at least two first side panels are respectively foldably attached to the first central panel at oblique fold lines, and the at least two second side panels are respectively foldably attached to the second central panel at oblique fold lines.

10. The package of claim 1 wherein the tray comprises a microwave interactive element for heating the food product when the package is placed in a microwave oven.

11. A blank for forming a package for heating a food product, the blank comprising:
a first central panel and at least two first side panels foldably connected to the first central panel, the first central panel and the first side panels being for forming a tray;
a second central panel and at least two second side panels foldably connected to the second central panel, the second central panel and second side panels being for forming a base for supporting the package formed from the blank;
an end panel respectively foldably connected to the first central panel and the second central panel; and
a support flap foldably connected to the second central panel, the support flap and the end panel being for supporting the tray above the base when the package is formed from the blank.

12. The blank of claim 11 wherein the second central panel comprises a tear line for separating the support flap from the second central panel.

13. The blank of claim 12 wherein the second central panel comprises a fold line for positioning the support flap relative to the second central panel.

14. The blank of claim 11 wherein the blank comprises retention features comprising an opening in at least one of the second side panels and a retention flap foldably connected to at least one of the first side panels, the retention flap comprising a locking portion shaped to be at least partially received in the opening.

15. The blank of claim 11 wherein the at least two first side panels are respectively foldably attached to the first central panel at oblique fold lines and the at least two second side panels are respectively foldably attached to the second central panel at oblique fold lines.

16. The blank of claim 11 further comprising a microwave interactive element attached to at least one of the first central panel and the second central panel.

17. A method of preparing a food product comprising:
obtaining a package comprising a tray, and end panel foldably connected to the tray, and a cover foldably connected to the end panel, the cover covers the tray in a closed position of the package;
opening the package comprising converting the cover into a base of the package by folding the tray relative to the end panel to place the tray above the cover;
placing a food product in the tray;
placing the opened package in a microwave oven by positioning the support on a surface of the microwave oven; and
heating the food product in the microwave oven.

18. The method of claim 17 wherein the cover comprises a support flap foldably attached to the cover and the opening of the package comprises upwardly folding the support flap relative to the cover and at least partially supporting the tray with the support flap.

19. The method of claim 18 wherein the tray comprises a first central panel and at least two first side panels foldably connected to the first central panel, and the cover comprises a second central panel and at least two second side panels foldably connected to the second central panel.

20. The method of claim 19 wherein the support flap is foldably connected to the second central panel.

21. The method of claim 17 wherein the package comprises a microwave interactive element attached to at least one of the first central panel and the second central panel, the heating the food product comprising heating the microwave interactive element to at least partially cook the food product.

22. The method of claim 17 wherein the opening the package comprises rotating the tray approximately 360 degrees relative to the cover to position the tray above the cover.

23. The method of claim 22 wherein the opening the package comprises inverting the end panel from the closed position of the package so that the end panel projects upward from the base.

24. The method of claim 17 wherein the opening the package comprises spacing the tray at least approximately 50 mm above a surface of the microwave oven.

25. The method of claim 17 wherein the opening the package comprises converting the package to a two-tier package with a top tier comprising the tray and a bottom tier comprising the cover.

26. A method of preparing a food product, the method comprising:
obtaining a package in a closed configuration so that a plurality of panels extends at least partially around an interior space of the package while the package is in the closed configuration, wherein the plurality of panels includes a first panel and a second panel that are respectively foldably connected to opposite edges of an end panel, the first panel includes opposite first and second sides, and the second panel includes opposite first and second sides, and wherein in the closed configuration
the interior space is at least partially positioned between
the first side of the first panel and
the first side of the second panel, and
the first side of the first panel faces toward the first side of the second panel;
reconfiguring the package into an elevating configuration, wherein the reconfiguring comprises
causing relative folding between the first panel, the second panel and the end panel so that, while the package is in the elevating configuration
at least a portion of the first panel is positioned above the second panel, and
the second side of the first panel faces toward, and is at least partially spaced apart from, the second side of the second panel, and
providing a support that is distant from the end panel and supports at least the portion of the first panel above the second panel; and
heating the food product while the food product is upon the first side of the first panel and the package is in the elevating configuration.

27. The method of claim 26 wherein the first panel is a first central panel and the second panel comprises a second central panel, the plurality of panels further comprising first side panels foldably connected to the first central panel and second side panels foldably connected to the second central panel.

28. The method of claim 27 wherein the providing the package in a closed configuration comprises providing a tray comprising the first central panel and first side panels and covering the tray with a cover comprising the second central panel and second side panels.

29. The method of claims 28 wherein the reconfiguring the package comprises rotating the tray approximately 360 degrees relative to the cover to position the try above the cover.

30. The method of claim 30 wherein the reconfiguring the package comprises inverting the end panel from the closed configuration so that the end panel projects upward from the second central panel.

31. The method of claim 26 wherein the second panel comprises a support flap foldably attached to the second panel, and providing the support comprises upwardly folding the support flap relative to the second panel.
